(19) United States
(12) Patent Application Publication
(10) Pub. No.: US 2025/0352421 A1
(43) Pub. Date: Nov. 20, 2025

(54) METHOD TO REDUCE HUMAN EXERTION DURING WALKING WITHOUT AFFECTING GAIT KINEMATICS

(71) Applicant: North Carolina State University, Raleigh, NC (US)

(72) Inventors: He Huang, Raleigh, NC (US); Varun Nalam, Raleigh, NC (US)

(21) Appl. No.: 18/867,695

(22) PCT Filed: May 19, 2023
(86) PCT No.: PCT/US2023/067239

§ 371 Date: Nov. 20, 2024

Related U.S. Application Data
(60) Provisional application No. 63/344,433, filed on May 20, 2022.

(51) Int. Cl. A61H 3/00; A61H 1/02; B25J 9/00

(52) U.S. Cl. CPC A61H 3/00; A61H 1/0262; B25J 9/0006; A61H 2003/007; A61H 2201/0165; A61H 2201/164; A61H 2201/165; A61H 2201/5005; A61H 2201/5069; A61H 2230/605

(57) ABSTRACT

Various examples are provided related to gait kinematics. A methodology for human in the loop optimization (HILO) for use of a hip exoskeleton is presented. In one example, a method includes monitoring a gait phase of an exoskeleton and controlling switching time between admittance parameters associated with actuator control of the exoskeleton, where the switching time is controlled based upon the monitored gait phase. The admittance parameters can be predetermined and can be user specific. The time of the switching can be determined from use of the exoskeleton and can be determined using reinforcement learning.

### CROSS REFERENCE TO RELATED APPLICATIONS

This application claims priority to, and the benefit of, co-pending U.S. provisional application entitled “Method to Reduce Human Exertion During Walking Without Affecting Gait Kinematics” having Ser. No. 63/344,433, filed May 20, 2022, which is hereby incorporated by reference in its entirety.

### BACKGROUND

Lower limb exoskeletons have been developed to augment movement for healthy individuals or provide physical rehabilitation/daily assistance for individuals with motor deficits. Achieving gait augmentation requires coordination between human intent and exoskeleton actions. Research aimed at gait augmentation has focused on able-bodied, healthy persons wearing single joint exoskeletons, aimed at reducing their energetic expenditure by modulating added torque at the joint during walking. Since the hip joint is the most energetically intensive joint during gait, several hip exoskeletons have been developed for gait augmentation purposes.

### SUMMARY

Embodiments of the present disclosure are related to gait kinematics. Human-in-the-loop (HIL) optimization usually optimizes assistive torque of exoskeletons to minimize the human's energetic expenditure in walking, quantified by metabolic cost. This formulation can, however, result in altered gait pattern of the human joint from the natural pattern or human preferred pattern, which is undesirable. A novel concept of HIL optimization of a hip exoskeleton is presented. The optimization can maintain the hip kinematics while providing optimal mechanical energy from the exoskeleton by modulating the admittance control. Policy iteration can be used to optimize the switching time within the gait phase, at which a parameter of the admittance controller can be altered to provide assistance.

In one aspect, among others, a method comprises monitoring a gait phase of an exoskeleton; and controlling switching time between admittance parameters associated with actuator control of the exoskeleton, where the switching time is controlled based upon the monitored gait phase. In another aspect, an exoskeleton comprises processing circuitry configured to implement the method. In one or more aspects, the switching time can be determined using reinforcement learning. The switching time can be iteratively determined based upon an error in stride angle of a hip joint of the exoskeleton.

In various aspects, the admittance parameters can be predetermined. The admittance parameters can comprise stiffness (K), damping (B), inertia (I) and equilibrium angle (θₑ). The admittance parameters can comprise a first set of admittance parameters and a second set of admittance parameters, wherein a value of at least one admittance parameter in the first set of admittance parameters differs from a corresponding value the at least one admittance parameter in the second set of admittance parameters. Each of a plurality of values of the first set of admittance parameters can differ from a corresponding value of the second set of admittance parameters. The at least one admittance parameter can be stiffness (K) and/or equilibrium angle (θₑ). The admittance parameters can be predetermined based at least in part upon user comfort. In one or more aspects, the gait phase can be monitored based at least in part upon electromyography (EMG) of a user of the exoskeleton and/or a joint angle of the exoskeleton. The gait phase can be monitored at a frequency of about 1000 Hz. The EMG can be monitored using surface EMG sensors.

In various aspects, the method can comprise determining the switching based upon an error in stride angle of a hip joint of the exoskeleton. The error can be determined based upon a comparison of a current stride angle of the hip joint and a reference stride angle for the hip joint. The reference stride angle can be determined based upon user operation of the exoskeleton in a zero-torque mode. The actuator control of the exoskeleton based upon switching the admittance parameters can preserve natural stride angle of a user of the exoskeleton. The actuator control of the exoskeleton based upon switching the admittance parameters can reduce exertion of the user over the gait phase. In some aspects, the admittance parameters can be switched between a first set of admittance parameters and a second set of admittance parameters at the switching time based upon the monitored gait phase. The method can further comprise controlling switching between the admittance parameters at a second switching time based upon the monitored gait phase, wherein the admittance parameters are switched to a third set of admittance parameters at the second switching time.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an image of an example of a modular hip exoskeleton, in accordance with various embodiments of the present disclosure.

FIG. 2 illustrates examples of assistance torque of the modular hip exoskeleton for three modes: equilibrium, stiffness extension and stiffness flexion, in accordance with various embodiments of the present disclosure.

FIG. 3 illustrates an example of a reinforcement learning implementation, in accordance with various embodiments of the present disclosure.

FIGS. 4A-4D illustrate examples of tuning performance for the three modes, in accordance with various embodiments of the present disclosure.

FIGS. 5A-5C illustrate examples of hip gait kinematic profile comparisons for the three modes, in accordance with various embodiments of the present disclosure.

FIGS. 6A and 6B illustrate examples of total power and normalized electromyography (EMG) responses for the three modes, in accordance with various embodiments of the present disclosure.

FIG. 7 illustrates examples of temporal distribution of power across the gait cycle for the three modes, in accordance with various embodiments of the present disclosure.

FIG. 8 is a schematic block diagram illustrating an example of a system employed for exoskeleton control, in accordance with various embodiments of the present disclosure.

### DETAILED DESCRIPTION

Disclosed herein are various examples related to gait kinematics. A new method of human in the loop optimization for a hip exoskeleton using reinforcement learning is proposed. The approach for reducing human exertion during walking using a hip exoskeleton can be classified under the human in loop optimization (HILO) technique. The prevalent HILO method is to optimize the torque provided to the hip joint using a hip exoskeleton based on metabolic cost assessments using volumetric oxygen consumption. In the new approach, the focus is on the local hip joint rather than generalized metabolic cost. Compared to prior approaches, this approach can ensure that gait kinematics are preserved during walking. This can ensure that the inter-limb and inter-joint coordination, which is important for balance, is maintained. Uses of the admittance parameter control methodology can include, but are not limited to, military applications to increase human endurance during walking, rehabilitation applications where users fatigue easily and need intervention to keep walking, and general rehabilitation where the robot can provide assistance which can gradually be reduced to ensure users relearn how to walk.

In all these applications, the algorithm can ensure that the kinematic behavior is maintained, so the neuromuscular behavior of the human is not altered. This ensures that the neural learning in rehabilitation is not affected for neurologically affected subjects, while the existing neural behavior to ensure balance is not compromised in able bodied individuals. Commercial applications can include increasing human endurance, e.g., in military applications and assisting with rehabilitation during physical therapy both in neurological conditions and orthopedic rehabilitation for lower limb injuries. Reference will now be made in detail to the description of the embodiments as illustrated in the drawings, wherein like reference numbers indicate like parts throughout the several views.

Coordination between human intent and exoskeleton actions is needed to achieve gait augmentation. Therefore, the exoskeleton control has been generally structured in a hierarchical way with the higher-level controller detecting the user's intent and the lower-level controller providing the needed assistance. The user intent can be recognized through electromyography (EMG) or gait events and predetermined corresponding torque can be provided to the limb. However, seamlessly coordinating the actions of human and exoskeleton is challenging. The provided torque affects the dynamics of the human-exoskeleton system, which can set the human in a different state compared to the recognized intent. Since the human's response to the exoskeleton torque is not predictable, careful manual tuning of the device control parameters is needed, and the approaches found limited adoption for able-bodied users.

To account for changes in human behavior, human-in-the-loop (HIL) optimization methods can be implemented. HIL optimization, in which a user-robot system is treated as a “black-box”, can be used to personalize the robotic control parameters automatically and heuristically. The HIL optimization algorithm can iteratively search for a fixed set of parameters that optimizes a specified objective function. For human gait augmentation, metabolic cost is the most used optimization objective. The set of parameters are often the parameters that characterize an assistive torque function, such as timings, shape, and magnitude, in a specific gait phase.

While HIL optimization methods account for variance in human response to assistance, the current formulation of HIL optimization for gait augmentation has several notable limitations. First, formulating the objective function using metabolic cost can lead to the challenge in the convergence of the algorithm because the metabolic cost measure is noisy and the influence of exoskeleton control on this human state in terms of energetic cost is unclear and indirect. In addition, the metabolic cost measure is impractical for daily use and responds slowly, further causing the optimization procedure to be inefficient. More importantly, the HIL optimization attempts at reducing metabolic cost measures are found to affect human gait kinematics, which can be undesired for healthy users. The second limitation is the structure of action in the exoskeleton control space that focuses on the definition of assistive torque profile. A fixed torque profile lacks the adaptability to natural variations in human gait, compromising the assistance and restricting movement.

The limitation of current HIL optimization provided motivation to reconsider the problem formulation for human gait augmentation via exoskeleton. Fundamentally different from the current concept, optimization of a hip exoskeleton assistance is proposed without changing the gait kinematics in local hip joint. Therefore, the objective function was formulated by the local hip motion, which is directly influenced by the exoskeleton control and is practical and reliable to use. An admittance control was designed as the low-level exoskeleton control, which is switched between two different sets of admittance values. The optimal time for switching the admittance value can be obtained through HIL optimization. Hence, the approach reduces dimensionality by optimizing only one parameter and ensures that the kinematics of the user is not affected, which can address the limitations of the forementioned approaches. The admittance control can ensure compliance in the system to account for natural variations in gait. Further, the admittance parameters can be adjusted based on user preference, ensuring user input, and user comfort during assistance.

This approach is made feasible by modulating the low-level control of the robot utilizing 1) unassisted hip kinematics as a target for optimization, 2) by modulating admittance instead of torque, which adds compliance to the system and 3) by optimizing for the switch time at which the controller switches between one set of admittance parameters to the other predetermined set instead of optimizing admittance values. These differences ensure that gait kinematics are maintained, the time for optimization is minimized and there is a reduction in human exertion.

The algorithm can perform human in the loop optimization to obtain the optimal switch times to ensure hip kinematics are maintained. The control switches between two predetermined sets of admittance parameters at these switch times. Using predetermined admittance parameters can ensure that the resulting assistance from these parameters reduces human exertion during walking. More importantly, since the hip kinematics are unaltered and the basic control is admittance instead of torque, the coordination mechanisms in the lower limb to ensure balance and react to disturbances are maintained. Further, reinforcement learning which optimizes the policy in addition to the switch times can be utilized. The optimized policy captures the relationship between human behavior and switch times, so the algorithm can easily obtain new switch times for any changes in environment.

Using unassisted hip kinematics as a goal for optimization can ensure that the exoskeleton reduces energetic exertion without sacrificing the inter-limb or inter-joint coordination required for balance and stability during locomotion. All prior approaches use metabolic cost as a measure, which is slow and does not account for alterations to gait kinematics. Modulating admittance instead of torque (which is the current state of art technique) can ensure compliance in system. This compliance is essential to account for natural variations in gait. The switch times where the control switches between two predetermined sets of admittance values can be optimized. This ensures only one parameter is optimized (switch time) instead of 6 admittance parameters reducing the time needed for optimization.

The feasibility of the proposed approach is now described. First, the performance of HIL optimization implemented using reinforcement learning (RL) based policy iteration in finding an optimal switching time for the objective function was evaluated. The power input from the exoskeleton as well as the muscle activation of the user were then analyzed to understand (i) if there is a reduction in human exertion during walking and (ii) which admittance parameters have to be switched for best energetic savings. Therefore, the new formulation of HIL optimization of hip exoskeleton control for gait augmentation is presented, and the new HIL optimization based on RL was implemented and applied to 3 modes using admittance control. Knowledge of physical human-robot interaction (e.g., the influence of control timing on switching different impedance values on human energetic exertion) has been obtained. The knowledge can aid in optimized control for minimizing the user's walking effort.

### Hardware

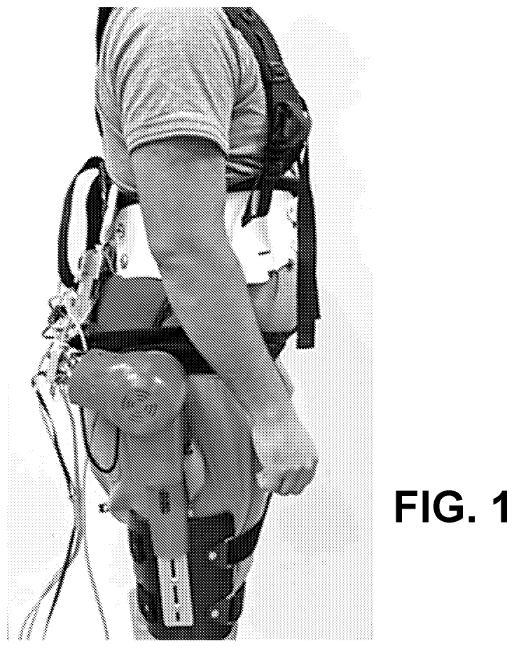

For the purposes of the study, a novel modular hip exoskeleton was utilized. FIG. 1 is an image of an example of a modular hip exoskeleton attached to an able-bodied user. The exoskeleton had been validated to safely interact with human subjects and provide the required assistance torque. While the hip exoskeleton was designed to provide assistance along 4 Degrees of Freedom, this study focused on the Flexion-Extension motion of the hip joint. For each of the two actuators controlling the flexion-extension of both limbs, an admittance controller was implemented with stiffness (K), damping (B) and inertia (I) about an equilibrium angle (θₑ). The input from the load cell (T) placed on the arm connecting the actuator to the limb was taken by the controller to generate a velocity signal satisfying the specified impedance parameters in accordance with eqn. (1). The controller was implemented on a real-time PC using EtherCat (TwinCAT 3.1) protocol executing at 1000 Hz.

$$T = K ( θ - {θ}_{e} ) + B \dot{θ} + I \ddot{θ} \qquad ( 1 )$$

### Assistance Protocol

The popular approach of assistance using hip exoskeletons is to set the impedance parameters (K, B, I and θₑ) close to zero for most of gait as a “zero-torque mode” and provide assistance at optimal phases of gait. The optimal assistance is generally provided by switching to a torque controller from the admittance (or impedance) controller and providing a predetermined torque profile. In this approach, non-zero admittance parameters can be provided across the entire gait cycle and one parameter can be switched at an optimal time during gait. The optimal time can be determined using an RL algorithm such that the gait kinematics of the hip joint remain similar to that during no assistance (zero torque mode). If the kinematics of the hip joint are the same during both zero torque and assistance modes, the total torque acting on the hip joint should be the same, eqns. (2) and (3), with the exoskeleton providing no torque in zero torque condition. Additionally, the work done across the gait cycle would be the same in both cases if the kinematics were not affected. Since the work done by the exoskeleton in the zero-torque mode would be 0, any positive work done by the exoskeleton would result in lower amount of work done by the human and thereby reducing human exertion, eqn. (5).

$$T = {I}_{tot} \ddot{θ} \qquad ( 2 )$$

$${T}_{assist} = {T}_{exo} + {T}_{human} = {T}_{zero torque} \qquad ( 3 )$$

$$Work = \int Td θ \qquad ( 4 )$$

$$Work = \int ( {T}_{exo} ) d θ + \int ( {T}_{Human} ) d θ \qquad ( 5 )$$

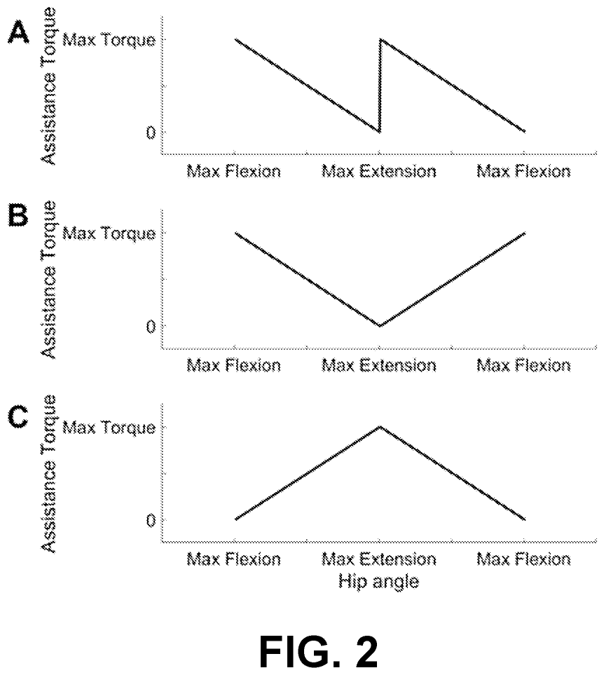

To test the hypothesis, the stiffness (K) and equilibrium angle (θₑ) were considered for switching during the algorithm, leading to three possible cases each having unique torque profile characteristics. In the first case, θₑ was switched from maximum extension to maximum flexion as observed during zero torque mode. In the second case, the stiffness was switched from positive (K) to negative (−K) and θₑ was fixed at maximum extension, while in the third the stiffness was switched from negative to positive with θₑ fixed at maximum flexion. The stiffness (K) was predetermined based on user comfort and the optimal time is determined using reinforcement learning. The hip joint kinematics and the power injected by the exoskeleton for each of the three cases was analyzed to validate the hypothesis. The three cases are referred to as the equilibrium mode, stiffness extension mode and stiffness flexion mode for the rest of the disclosure. FIG. 2 illustrates examples of the assistance torque (torque in direction of motion) for (A) the equilibrium mode, (B) the stiffness extension mode, and (C) the stiffness flexion mode.

### Reinforcement Learning Control

The goal of reinforcement learning control was to obtain the optimal switch times of assistance to be validated for each of the three modes. The heel strike of each foot was taken as the start of a gait cycle and the switch time was normalized to the gait cycle. The stride angle of the hip, which is the angle between maximum flexion and extension across a gait cycle was compared to the observed stride angle in zero torque mode to assess the optimality of the switch time. For the reinforcement learning (RL) problem, the state (x) was considered to be the error in stride angle of the hip joint and the action (u) was the change in switch time. An initial switch time was chosen randomly at the start of the algorithm.

The control uₖ, the action at the k-th iteration, was obtained from the control policy (x) as shown in eqn. (6) in which δₖ was discounted noise added to facilitate exploration. Additionally, a cost (C) for each iteration is estimated using eqn. (7), where Q and R are positive definite matrices.

$${u}_{k} = π ( {x}_{k} ) + {δ}_{k} \qquad ( 6 )$$

$$C ( {x}_{k} , {u}_{k} ) = {x}_{k}^{t} {Qx}_{k} + {u}_{k}^{t} {Ru}_{k} \qquad ( 7 )$$

Define the state-action Q-value function as:

$$Q ( {x}_{k} , {u}_{k} ) = C ( {x}_{k} , {u}_{k} ) + {\sum }_{j = 1}^{∞} γ C ( {x}_{k + j} , π ( {x}_{k + j} ) ) \qquad ( 8 )$$

where C(xₖ, uₖ) is the stage cost or instantaneous cost function and γ is a discount factor. Note that the Q(xₖ, uₖ) value is a performance measure when action uₖ is applied at state xₖ and the control policy π is followed thereafter. A least-squares policy iteration was used to solve for the optimal policy π* from the optimal Q*value.

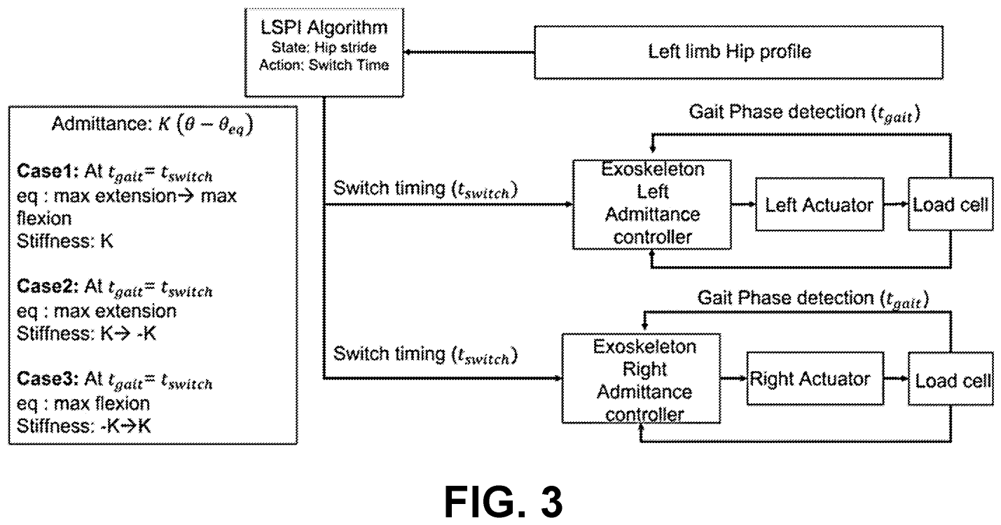

A sample comprising the state, the action and the reward was obtained every iteration. The sample was collected across 8 gait cycles obtained with the updated switch time and the state was obtained by averaging the hip stride angle across the last 5 gait cycles, allowing 3 cycles for transition. Monitoring can be carried out at frequencies of about 100 Hz or greater, about 500 Hz or greater, about 1000 Hz or greater, or at other appropriate frequency between those indicated. For example, monitoring at a frequency of 1 kHz allows switching to be controlled at intervals of 0.001 sec. FIG. 3 illustrates an example of a realization of the reinforcement learning implementation. The policy (x) was updated every 8 iterations using the least squares policy iteration on collected samples to further accelerate the convergence. The switch time was found to have converged when the cost was within a predetermined margin for three consecutive samples.

### Experimental Protocol and Analysis

The purpose of this study was to verify if an optimal switching time could be obtained for the three modes using RL and, further investigate the power and muscle activation characteristics of the three modes during optimal switching times. One subject (Age: 29, Sex: Male, Height: 171 cm and Weight: 78 Kg) had been recruited to perform the trial. The study was approved by an institutional review board and the participant provided informed consent. Surface electromyography (EMG) sensors (Motion-labs MA-300, LA, USA), were placed on the Gluteus Maximus (GLU), Bicep Femoris (BF), Semitendinosus (Semi), Vastus Lateralis (Vast) and Rectus Femoris (RF) muscles of both limbs of the subject. The entire study was performed while the subject was instructed to walk on a treadmill set to 1.2 m/s.

Prior to the tuning trial, the subject was instructed to walk without the exoskeleton and with the exoskeleton in zero torque mode for 2 minutes to obtain the baseline EMG and the reference stride angle for the hip joint. Three tuning trials were then performed for each of the three modes resulting in a total of 9 tuning trials. The admittance parameters K, B and I were set to 10 Nm/rad, 0.5 Nms/rad and 0.1 Kgm², respectively, and the stiffness was lowered in case of user discomfort. The tuning trials were performed until convergence (e.g., within a predefined threshold) unless the algorithm failed to converge within 8 min. If the tuning trial converged, a validation trial was performed with the optimal switching time obtained from the tuning trial. The subject was instructed to walk on the treadmill for 2 min for the validation trial, while the exoskeleton provided assistance. A total of 20 trials, including 9 tuning and 9 validation trials were performed for the study. Sufficient rest was provided between trials to ensure subject comfort and prevent fatigue.

To analyze the validity of each of the three approaches, the number of iterations taken to converge as well as the optimal switching time behavior of the algorithms were analyzed. In addition, the kinematics of the hip joint was compared between the zero-torque mode and the optimal assistance mode for each of the three modes. To compare the kinematic behavior, the variance accounted for (% VAF or R²) and Pearson's coefficient (correlation coefficient) for each trial is estimated. Finally, the power injected by the exoskeleton into the hip-exoskeleton complex as well as the muscle activation of predominant flexor and extensor muscles is evaluated across the gait cycle. The muscle activations are normalized using the observed muscle activations of corresponding muscles during normal walking without the exoskeleton. The observed results and inferences are described below.

### Results

Tuning trials were performed for all three modes. While the subject found the stiffness during equilibrium mode to be comfortable, the stiffness was reduced to 5 Nm/rad during stiffness extension and stiffness flexion mode to ensure user comfort. The convergence behavior, the kinematics along with the power and EMG behavior are described below.

### Convergence

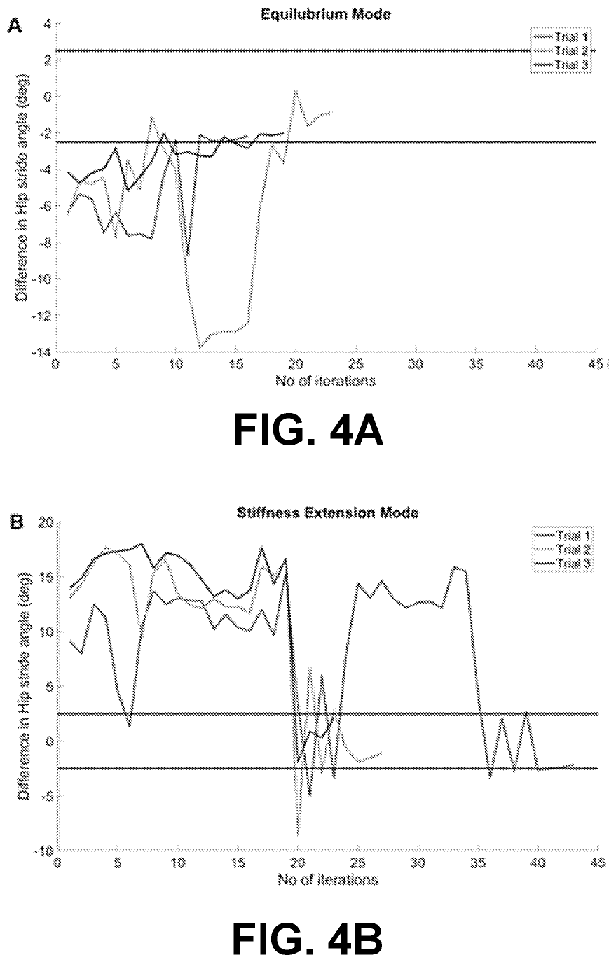

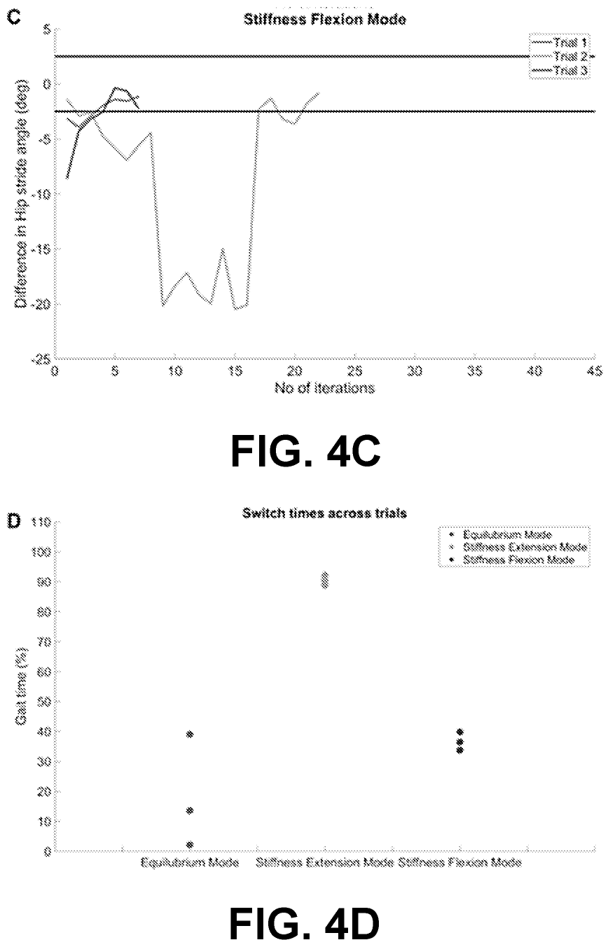

FIGS. 4A-4C illustrate examples of the tuning performance for equilibrium mode, stiffness extension mode and stiffness flexion mode, respectively. The algorithm only converged once the angles were within ±2.5 degrees of hip stride angle observed in zero torque mode. FIG. 4D illustrates the optimal switch timing across trials for all three modes. As shown in FIGS. 4A-4C, the algorithm converged to an optimal solution in all the three modes.

For the equilibrium point mode, the algorithm converged between 16-24 iterations for all three trials. Since the policy updated every 8 iterations, the third policy could be inferred to be the ideal policy for each trial. In comparison, two of the trials in the stiffness extension mode converged around 24-28 iterations, while the third one took over 40 iterations to converge. Based on the oscillations in the state value, it can be inferred that the hip joint-exoskeleton complex was unstable leading to varying human behavior, thereby affecting convergence. Finally, the stiffness flexion trials converged the fastest. Two of the trials converged even without an updated policy, which implies that the random policy was sufficient to aid in convergence of the switch time. The third trial, converged in 23 iterations and seemed to perform similar to the other two trials as soon as the policy was updated. Overall, the algorithm seemed to converge faster for stiffness flexion mode and the slowest for the stiffness extension mode.

Looking at the final switching times, the equilibrium point mode converged to different optimal times while both extension and flexion stiffness mode converged to similar switching time for all three trials. The results imply that there is only one optimal solution for the trials in which stiffness is switched but multiple optimal solutions when equilibrium point is switched. Understanding the differences in power input during the various solutions can help in developing optimal targets for the algorithm.

### Kinematics

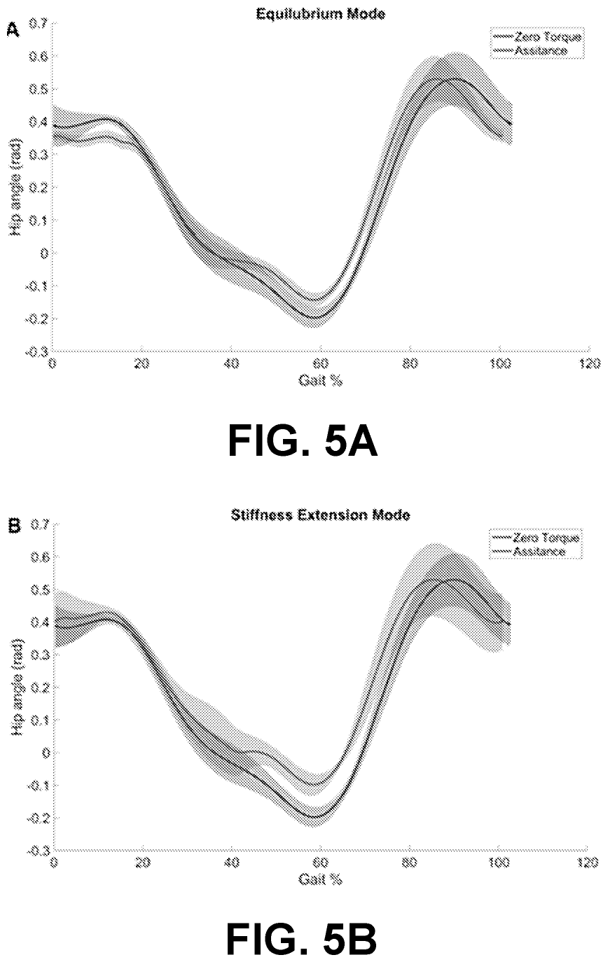

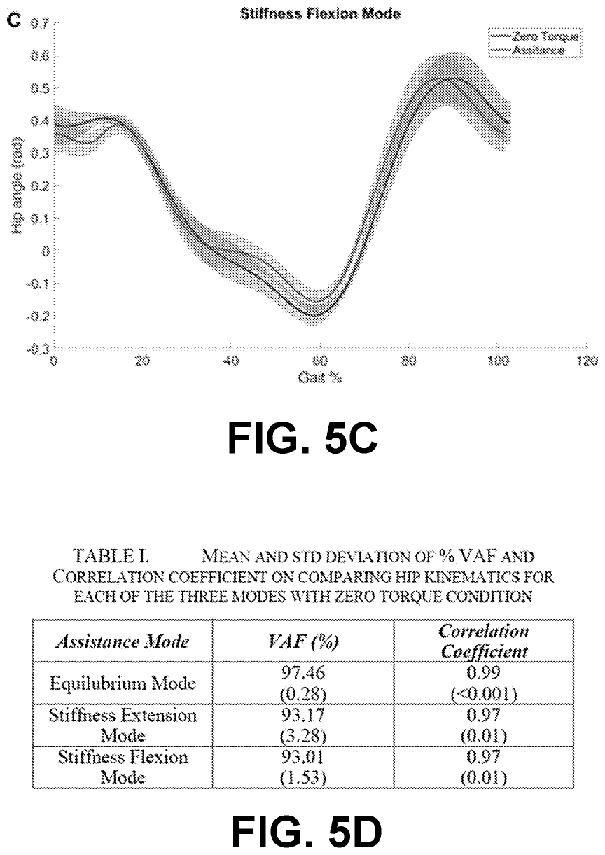

Since the algorithm only considered the maximum extension and flexion of the hip joint, it is possible that the kinematics of the hip joint were radically altered with assistance even when the hip stride angle was the same. FIGS. 5A-5C illustrate examples of comparisons of hip gait kinematic profiles for the three modes: equilibrium mode, stiffness extension mode and stiffness flexion mode, respectively. On investigating the % VAF and Pearson's coefficient, the equilibrium point mode was found to have a % VAF greater than 97% with the correlation coefficient greater than 0.99 when the observed hip profile is compared to that of the zero-torque condition. For the stiffness modes, the % VAF was found to be greater than 93% with correlation greater than 0.96 for both cases, which shows that the gait kinematics of the hip remained consistent even with assistance. The kinematic profile of the hip for the three modes is shown in FIGS. 5A-5C while Table I of FIG. 5D shows the mean and standard deviations of % VAF and correlation for the three modes.

### Power and EMG

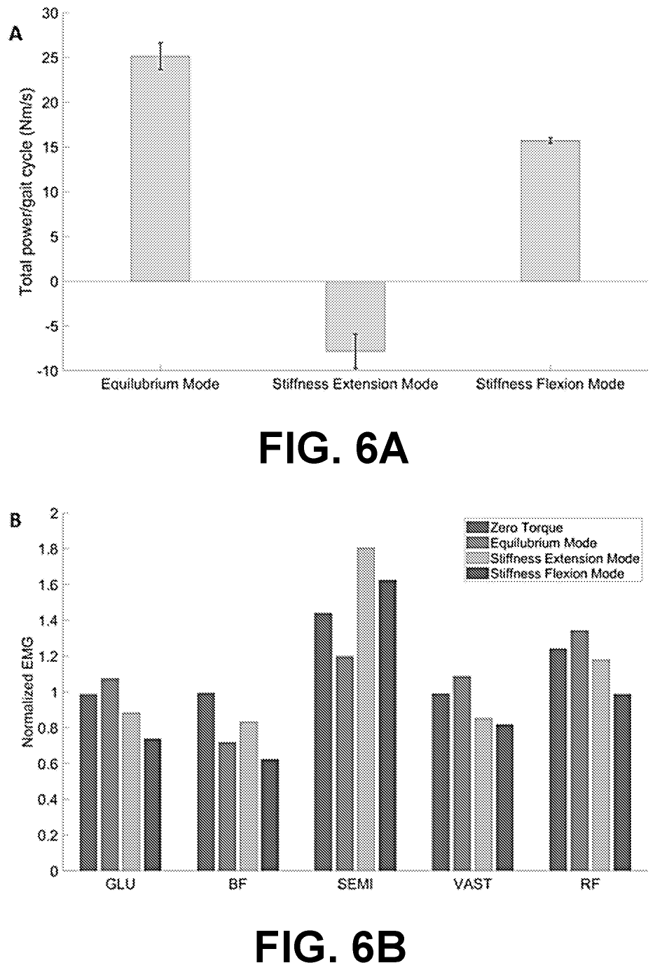

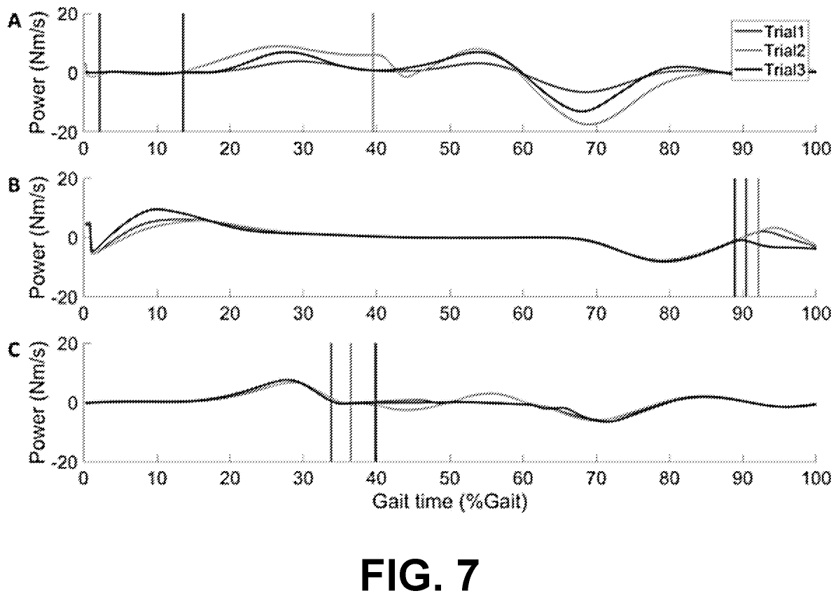

It is observed that the total power injected into the system during a gait cycle is 25.14 Nm/s for equilibrium point mode, −7.82 Nm/s for stiffness extension mode and 15.73 Nm/s for stiffness flexion mode. FIG. 6A illustrates examples of total power across the gait cycle for the three modes and FIG. 6B illustrates normalized EMG responses of predominant thigh muscles across gaits. From eqn. (5), it can be asserted that both equilibrium mode and stiffness flexion mode result in reduced exertion for the subject during gait, while stiffness extension mode resulted in increased exertion. FIG. 7 illustrates examples of the temporal distribution of power across the gait cycle for (A) the equilibrium mode (top), (B) the stiffness extension mode (middle), and (C) the stiffness flexion mode (bottom). The vertical lines denote switching times for each trial. Further investigating the temporal nature of the power input, a later switching time during equilibrium point mode resulted in a higher net positive power during extension but a similarly higher net negative power during flexion. Hence, while the switching times for all three trials were different, the total power was similar. Looking at the EMG responses, the equilibrium point mode resulted in reduction in muscle activity of the extensor muscles (BF and Semi) with a slight increase in flexor muscle activation. The increased activation in flexor muscles correlated with the negative power observed in the later part of gait in equilibrium point mode as shown in FIG. 7. In comparison, stiffness extension mode showed an increase in extensor muscle activity compared to flexor muscle activity, while stiffness flexion mode shows a reduced activity in flexor muscles as well as one of the extensor muscles (BF).

### Discussion

The purpose of the study was to test the feasibility of the HIL approach aimed at reducing human exertion without affecting the hip kinematics during gait. The viability of using reinforcement learning to obtain the optimal timings as well as the impact of admittance parameters modulated to ensure reduction in human exertion were analyzed. The convergence results have shown that the algorithm is capable of finding an optimal switching time of an admittance control parameters without changing the gait pattern, while the results of exoskeleton augmentation power validate the admittance control approach in reducing human exertion for two of the three modes analyzed. For example, consideration of the stiffness and equilibrium angle can provide three possible modes of operation for the algorithm: (i) switching the equilibrium point, (ii) switching stiffness while equilibrium point is set at maximum extension and, (iii) maximum flexion. The optimization algorithm was found to converge for all three modes, with the equilibrium mode resulting in multiple solutions. Analysis of power injected by the exoskeleton in the three modes showed that the first and third mode reduced human energetic exertion while the second mode increased human exertion.

### Implications of the Observed Results

The reinforcement learning algorithm was found to converge for all three modes analyzed in the results. Based on ease of convergence, equilibrium and stiffness flexion mode were found to be more stable approaches. One possible explanation for the multiple switching times in equilibrium mode could be that the hip stride angle is robust to changes in switching time. However, that possibility can be eliminated as the state was found to vary with varying switching times as shown in the convergence plot. Interestingly, since the total power injected into the system during trials was similar, the optimal timing from the possible solutions can be chosen based on user preference without any energetic penalty.

Even though the algorithm uses only hip stride angle as the state for the algorithm, the resulting kinematics of the hip joint correlated with the zero-torque condition (r>0.97 and r²>93%). So, it is not necessary to add additional state information for the algorithm to match the kinematics of the hip joint to that of no assistance case, reducing the complexity of the required algorithm. More importantly, since the kinematics were not altered, any positive energy injected by the exoskeleton can result in reduction in human exertion which was further validated through the observed EMG measures. A positive power input during earlier phases of gait as seen in the temporal power distribution graph of equilibrium mode (see FIG. 7) correlated with reduction in extensor muscle activation, while positive power input in the later parts of gait observed in both stiffness modes resulted in lower activation of flexor muscles. Overall, positive power across gait was observed to correlate with reduced extensor muscle activity, specifically to that of the Bicep Femoris. BF activation can therefore be used as a state to further optimize for reduced human exertion in other iterations.

### Significance of the Current Approach

HIL approaches aimed at reducing metabolic costs were found to alter gait kinematics. However, changes in gait kinematics might not be preferred by the user even with the resulting energetic cost savings. The current approach reduces human exertion without any changes to the gait kinematics by compensating for some of the torque generated by the user and could be preferred by users compared to other approaches. The choice of using an admittance controller and altering parameters at an optimal time is safer. Admittance controllers have compliance incorporated into the system enabling the controller to adapt to any changes in the natural gait pattern of the user. In comparison, the optimized torque profiles cannot adapt to any changes in the gait pattern after optimization. So, the torque profile could have adverse effects in response to natural variation in human gait. In addition, even the simplest realizations of torque profile utilize multiple parameters that are optimized, resulting in a longer duration of optimization which is eliminated in this approach. The admittance parameters are predetermined based on user preference and the only parameter optimized is the switching time during the gait cycle. This ensures that the optimization algorithm is simplified while also taking into account user preference for assistance.

Finally, the optimal torque profiles may not translate across varying conditions such as incline and decline walking, varying environments or walking speeds, resulting in the need for separate optimization process for each condition. The current approach uses least squares policy iteration, which finds the optimal policy in addition to the switching time. While the switching time might not translate across the various walking conditions, the policy function relates to the behavior of the hip-exoskeleton complex and can be independent of the walking conditions and environment. Hence, the proposed approach based on policy iteration is better equipped to adapt to different walking conditions and environments by utilizing the optimal policy deduced by the optimization.

While the current approach has been shown to reduce human exertion, it is possible that human exertion could be further reduced during gait. Since the RL algorithm can be scaled, additional switching times could be introduced in a gait cycle in either the equilibrium mode, stiffness flexion mode or a combination of both. Understanding the relationship between the admittance parameters and switching time can aid in development of better tuning protocols that can emphasize user preference and ensure user safety during optimization. The optimization can be performed at low admittance parameter values to mitigate effects of non-optimal switch times and on convergence, admittance parameters preferred by the user could be tuned using the relationship. Successful realization of this approach would simultaneously facilitate user preferred assistance and reduction in energetic cost of locomotion.

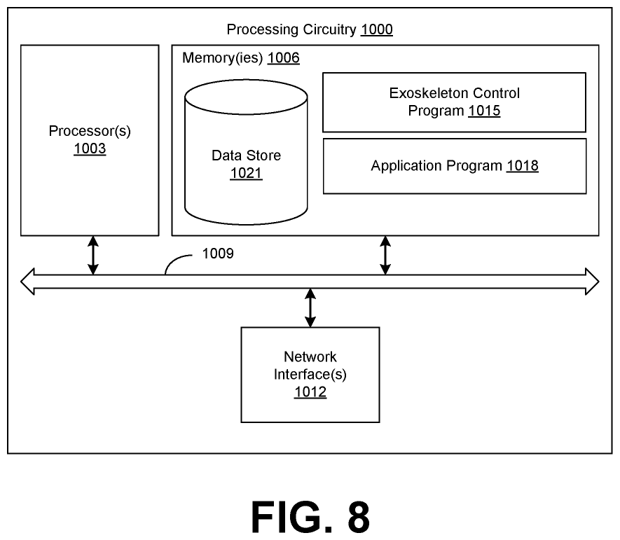

With reference to FIG. 8, shown is a schematic block diagram of processing circuitry 1000 that can be used for control of exoskeletons or other applications, in accordance with various embodiments of the present disclosure. The processing circuitry 1000 can comprise one or more computing/processing device such as, e.g., a controller, smartphone, tablet, computer, etc. The processing circuitry 1000 can include at least one processor circuit, for example, having a processor 1003 and a memory 1006, both of which are coupled to a local interface 1009. To this end, each processing circuitry 1000 may comprise, for example, at least one server computer or like device, which can be utilized in a cloud-based environment. The local interface 1009 may comprise, for example, a data bus with an accompanying address/control bus or other bus structure as can be appreciated.

In some embodiments, the processing circuitry 1000 can include one or more network interfaces 1012. The network interface 1012 may comprise, for example, a wireless transmitter, a wireless transceiver, and/or a wireless receiver. The network interface 1012 can communicate to a remote computing/processing device or other components using a Bluetooth, WiFi, or other appropriate wireless protocol. As one skilled in the art can appreciate, other wireless protocols may be used in the various embodiments of the present disclosure. The network interface 1012 can also be configured for communications through wired connections. The processing circuitry 1000 can also include a user interface that can enable local access and/or remote access through a user device (e.g., smartphone, tablet, computer, etc.) via the network interface.

Stored in the memory 1006 are both data and several components that are executable by the processor(s) 1003. In particular, stored in the memory 1006 and executable by the processor 1003 can be an exoskeleton control application 1015 which can utilize the admittance parameter control as disclosed herein, and potentially other applications 1018. In this respect, the term “executable” means a program file that is in a form that can ultimately be run by the processor(s) 1003. Also stored in the memory 1006 may be a data store 1021 and other data. In addition, an operating system may be stored in the memory 1006 and executable by the processor(s) 1003. It is understood that there may be other applications that are stored in the memory 1006 and are executable by the processor(s) 1003 as can be appreciated. The user interface can allow access to the exoskeleton control application 1015 and/or the data store 1021. For example, the user interface can be used to set admittance parameters for use as previously discussed or access information stored during operation of the exoskeleton.

Examples of executable programs may be, for example, a compiled program that can be translated into machine code in a format that can be loaded into a random access portion of the memory 1006 and run by the processor(s) 1003, source code that may be expressed in proper format such as object code that is capable of being loaded into a random access portion of the memory 1006 and executed by the processor(s) 1003, or source code that may be interpreted by another executable program to generate instructions in a random access portion of the memory 1006 to be executed by the processor(s) 1003, etc. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores, and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, ultrasound or other devices. The processor 1003 may be of electrical or of some other available construction.

Although the exoskeleton control application 1015, and other various applications 1018 described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the stiffness reconstruction application 1015, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the stiffness reconstruction application 1015, may be implemented and structured in a variety of ways. For example, one or more applications described may be implemented as modules or components of a single application. For example, the exoskeleton control application 1015 can include a wide range of modules such as, e.g., an initial model or other modules that can provide specific functionality for the disclosed methodology. Further, one or more applications described herein may be executed in shared or separate computing/processing devices or a combination thereof. For example, a plurality of the applications described herein may execute in the same processing circuitry 1000, or in multiple computing/processing devices in the same computing environment.

A number of advantages are offered with the disclosed methodology. The sensing in existing systems is based on volumetric oxygen consumption, which is a slow sensor. This increases the optimization time. In comparison, using hip kinematics estimated by on board encoders is instantaneous. Current approaches alter hip kinematics which interferes with the neural coordination (interlimb and interjoint), which makes it harder to maintain balance due to any disturbances. This approach maintains hip kinematics after optimization which ensures better balance and stability. Existing approaches use torque modulation, which causes rigidity in system and lack adaptation to gait variability. Using admittance controller ensures that there is compliance in the system which is essential for higher functioning individuals. Since the disclosed approach uses only kinematics, the sensors can be already incorporated into the device. This allows the approach to be easily translated outside lab environments. Metabolic cost sensors utilize instrumentation that cannot be easily taken outdoors from instrumented gait labs.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method, comprising:
monitoring a gait phase of an exoskeleton; and
controlling switching time between admittance parameters associated with actuator control of the exoskeleton, where the switching time is controlled based upon the monitored gait phase.

2. The method of claim 1, wherein the switching time is determined using reinforcement learning.

3. The method of claim 2, wherein the switching time is iteratively determined based upon an error in stride angle of a hip joint of the exoskeleton.

4. The method of claim 1, wherein the admittance parameters are predetermined.

5. The method of claim 4, wherein the admittance parameters comprise stiffness (K), damping (B), inertia (I) and equilibrium angle (θₑ).

6. The method of claim 4, wherein the admittance parameters comprise a first set of admittance parameters and a second set of admittance parameters, wherein a value of at least one admittance parameter in the first set of admittance parameters differs from a corresponding value the at least one admittance parameter in the second set of admittance parameters.

7. The method of claim 6, wherein each of a plurality of values of the first set of admittance parameters differs from a corresponding value of the second set of admittance parameters.

8. The method of claim 6, wherein the at least one admittance parameter is stiffness (K).

9. The method of claim 6, wherein the at least one admittance parameter is equilibrium angle (θₑ).

10. The method of claim 4, wherein the admittance parameters are predetermined based at least in part upon user comfort.

11. The method of claim 1, wherein the gait phase is monitored based at least in part upon electromyography (EMG) of a user of the exoskeleton.

12. The method of claim 11, wherein the gait phase is monitored based upon a joint angle of the exoskeleton.

13. The method of claim 11, wherein the gait phase is monitored at a frequency of about 1000 Hz.

14. The method of claim 1, comprising determining the switching based upon an error in stride angle of a hip joint of the exoskeleton.

15. The method of claim 14, wherein the error is determined based upon a comparison of a current stride angle of the hip joint and a reference stride angle for the hip joint.

16. The method of claim 15, wherein the reference stride angle is determined based upon user operation of the exoskeleton in a zero-torque mode.

17. The method of claim 1, wherein the actuator control of the exoskeleton based upon switching the admittance parameters preserves natural stride angle of a user of the exoskeleton.

18. The method of claim 17, wherein the actuator control of the exoskeleton based upon switching the admittance parameters reduces exertion of the user over the gait phase.

19. The method of claim 1, wherein the admittance parameters are switched between a first set of admittance parameters and a second set of admittance parameters at the switching time based upon the monitored gait phase.

20. The method of claim 19, further comprising controlling switching between the admittance parameters at a second switching time based upon the monitored gait phase, wherein the admittance parameters are switched to a third set of admittance parameters at the second switching time.
